(19) United States
(12) Patent Application Publication
(10) Pub. No.: US 2015/0280782 A1
(43) Pub. Date: Oct. 1, 2015

(54) METHOD AND DEVICE FOR TRANSMITTING DATA VIA A LOAD LINE AND LIGHTING SYSTEM

(71) Applicant: TRIDONIC GMBH & CO KG, Dornbirn (AT)

(72) Inventors: Kai Airbinger, Hard (AT); Simon Lecker, Dornbirn (AT); Roman Ploner, Hohenems (AT)

(73) Assignee: TRIDONIC GMBH & CO KG, Dornbirn (AT)

(21) Appl. No.: 14/440,340

(22) PCT Filed: Nov. 6, 2013
(86) PCT No.: PCT/AT2013/000183

§ 371 Date: May 1, 2015

(30) Foreign Application Priority Data
Nov. 6, 2012 (AT) GM 431/2012

(51) Int. Cl. H04B 3/54; H05B 33/08; H05B 37/02

(52) U.S. Cl. CPC H04B 3/54; H05B 37/0263; H05B 33/0896; H05B 33/0848; H04B 2203/542

(57) ABSTRACT

A data transmission from a control device (100) to a load (50) is carried out via a load line (40). In the method, a switching means (106) is controlled in order to increase a resistance of a line path between an input terminal (101) and an output terminal (102) of the control device (100). A voltage is detected in the control device (100) in order to identify a phase position of a supply voltage. The supply voltage is influenced depending on the identified phase position and the data to be transmitted in order to transmit a data packet.

### FIELD OF THE INVENTION

The invention relates to a method and a device for controlling an operating device for an illuminant. The invention relates, in particular, to methods and devices in which a data packet having a plurality of data bits can be transmitted via a load line via which energy is supplied.

### BACKGROUND

Dimmers can be used for the brightness control of illuminants. In the case of luminaries operating on the basis of conventional illuminants such as incandescent bulbs, the brightness regulation in the dimmer can be carried out by means of a phase gating or phase cutting of the supply voltage of the luminaire. In this case, the power of the luminaire is reduced by a momentary interruption of the supply voltage being brought about after or before the zero crossing of the supply voltage, such that the power of the luminaire is reduced depending on the time duration of the interruption.

Control devices can be used for brightness or color control in order to communicate control signals to an operating device for an illuminant. An evaluation circuit provided in the operating device evaluates said control signals and correspondingly sets the brightness. Such a control can also be used for color control. Such a type of control is suitable in particular for lighting devices based on illuminants in the form of gas discharge lamps or light emitting diodes (LEDs).

Indentation sockets for dimmers into which control devices of the above-mentioned type are intended to be inserted often have a wiring in the form of a two-wire system. The control device correspondingly has an input terminal for connection to a phase conductor of a supply source and an output terminal for connection to a load line. Often, however, there is no terminal for a neutral conductor in the indentation socket. If a non-ohmic load is supplied with energy via the load line, this results in a phase shift between current flowing via the load line and supply voltage. For a data transmission carried out in a manner temporally coordinated with the supply voltage, the phase angle of the supply voltage has to be ascertained.

It is an object of the invention to provide a method and a device for data transmission via a load line which are suitable for use for luminaries based on non-conventional illuminants and allow reliable data transmission by the influencing of the supply voltage.

### SUMMARY

This object is achieved by means of a method, a device and a lighting system comprising the features specified in the independent claims. The dependent patent claims define developments of the invention.

In accordance with one exemplary embodiment, a method for data transmission from a control device to a load via a load line, in particular for data transmission to an operating device of an illuminant, is specified. The method involves controlling a switching means in order to increase a resistance of a line path between an input terminal and an output terminal of the control device. A voltage is detected in the control device in order to identify a phase angle of a supply voltage. The supply voltage is subsequently influenced in a targeted manner depending on the identified phase angle and depending on data to be transmitted in order to transmit a data packet.

Such a method allows the detection of a phase angle, in particular the detection of a zero crossing of the supply voltage, even if the control device is interconnected in a two-wire system and has no input for a neutral conductor of the supply source. As a result, by way of example, phase gating and/or phase cutting can be modulated onto a sequence of half-cycles of the supply voltage in a targeted manner in order to transmit a data packet having a plurality of data bits.

The line path between input terminal and output terminal of the control device can be switched into a high-impedance state for a time duration which is less than a time duration or equal to a time duration during which an energy store integrated in the operating device of the illuminant, for example a charging capacitor, can maintain the operation of the illuminant. The phase angle of the supply source can thus be identified without the operation of the illuminant being interrupted. The line path between the input terminal and the output terminal of the control device can be switched into a high-impedance state for a time duration which is greater than a time duration or equal to a time duration during which an interference-suppression capacitor (also designated as x-capacitor) of the operating device is discharged. A zero crossing of the supply voltage can be identified reliably in this way.

As a result of the switching of the switching means, the control device is switched into an off state, as a result of which the current flow between supply source and load is greatly reduced or completely interrupted by the control device. The control device can be switched into the off state in a targeted manner for a short time interval in order to identify the phase angle of the supply voltage. This can be effected for a time duration having a length of up to 15 ms. The voltage in the control device can be monitored while the control device is switched into a high-impedance off state.

The method can involve monitoring a current output via the output terminal to the load line. The switching means can be switched into an off state upon a zero crossing of the current. The switching means can be switched into an off state in a targeted manner if an actuation of a setting element is detected and the current flowing through the control device to the operating device has a zero crossing. Detecting the phase angle of the supply voltage can comprise detecting a zero crossing of the voltage which is detected in the control device while the switching means is switched into the off state. For the purpose of transmitting the data packet, the supply voltage can be influenced in time intervals which depend on a time at which the zero crossing of the detected voltage occurs. For this purpose, by way of example, the supply voltage can be reduced in a targeted manner and in a manner temporally coordinated with the zero crossing of the supply voltage in order to generate a phase gating and/or phase cutting.

A phase gating and/or phase cutting of at least one half-cycle of the supply voltage can be generated. For this purpose, the switching means can be controlled in a predefined temporal relation with the instant at which the zero crossing of the supply voltage occurs. A phase gating and/or phase cutting can be generated in each case for at least two half-cycles of the supply voltage which have different signs. In this way, two data bits of the data packet can be transmitted per full cycle of the supply voltage. A phase gating and/or phase cutting can be generated selectively in each case for a plurality of half-cycles of a sequence of half-cycles of the supply voltage in order to code a dimming value and/or a color value. The sequence of data bits can comprise at least one start bit, a bit code for coding the dimming value and/or color value and at least one stop bit. The sequence of data bits can comprise at least ten data bits, for example. In a further configuration, the sequence of data bits can comprise at least one start bit, a bit code indicating an incrementation or decrementation of a dimming value and/or color value, and at least one stop bit. For the purpose of generating the phase gating and/or phase cutting, the switching means can be switched into an off state in a manner temporally coordinated with the identified phase angle. A series circuit formed by two switching means, for example two power semiconductor components, can be connected between the input terminal and the output terminal in order to be able to generate a phase cutting or phase gating both for half-cycles having a positive sign and for half-cycles having a negative sign.

The input terminal of the control device can be coupled to a phase conductor of a supply source, for example a power supply system voltage source. The output terminal of the control device can be coupled to the load line. The control device need not have a terminal for a neutral conductor of the supply source.

An actuation of a setting element of the control device can be monitored. The setting element can comprise for example one pushbutton switch or a plurality of pushbutton switches, a rotatable setting element or other actuatable elements. The control of the switching means which is used to switch the line path between input terminal and output terminal of the control device with high impedance can be carried out if an actuation of the setting element is identified. The control circuit can generate a supply voltage for the operation of the control circuit from the voltage dropped between input terminal and output terminal of the control device. The control device can be configured such that the control circuit is supplied with energy selectively only if an actuation of the setting element is identified.

According to a further exemplary embodiment, a control device is specified, which is configured for data transmission via a load line. The control device comprises an input terminal configured to be coupled to a phase conductor of a supply source. The control device comprises an output terminal configured to be coupled to a load line for supplying a load. The control device comprises a control circuit configured to interrupt a current supply for the load. The control circuit is configured to detect a voltage in the control device while the current supply for the load is interrupted in order to identify a phase angle of a supply voltage. The control circuit is configured to influence the supply voltage depending on the identified phase angle and depending on data to be transmitted for transmitting a data packet.

The control device can comprise a switching means between input terminal and output terminal, to which the control circuit is coupled in order to switch the switching means into an off state. A series circuit formed by two switching means, for example by two power semiconductor components, can be connected between the input terminal and the output terminal. The control circuit can be coupled to a gate of the two power semiconductor components in order to switch in each case at least one of the two switching means into a high-impedance state by influencing the potential at the gate. The two power semiconductor components can be interconnected such that they are both in a low-impedance state in continuous operation if the supply source supplies a voltage, and are switched into an off state by the control circuit only in a targeted manner.

The control device can be a dimmer.

Developments of the control device and the effects respectively achieved therewith correspond to the developments of the method.

According to a further exemplary embodiment, a lighting system is specified. The lighting system comprises at least one operating device for an illuminant and a control device according to one exemplary embodiment. The control device is coupled to the at least one operating device via a load line.

The at least one operating device can comprise a charging capacitor designed such that the illuminant can continue to be operated during a time interval in which the control device interrupts an energy supply for the purpose of identifying the phase angle of the supply voltage. The at least one operating device can furthermore comprise an interference-suppression capacitor connected in parallel with input terminals of the operating device. The at least one operating device can comprise an evaluation circuit, which checks a supply voltage for presence of phase gating and/or phase cutting. The evaluation circuit can be configured to check half-cycles of the supply voltage having a positive sign and also half-cycles of the supply voltage having a negative sign with regard to the presence of a phase gating and/or phase cutting. The evaluation circuit can be configured to determine a dimming value and/or a color value from a sequence of phase gating and/or phase cutting which are modulated on a sequence of half-cycles of the supply voltage. The evaluation circuit of the operating device can be configured to perform a brightness change and/or color change depending on the sequence of phase gating and/or phase cutting.

The at least one operating device can comprise at least one LED converter.

### BRIEF DESCRIPTION OF THE DRAWINGS

Further features, advantages and functions of exemplary embodiments of the invention will become apparent from the following detailed description with reference to the accompanying drawings, in which identical or similar reference signs designate units having an identical or similar function.

FIG. 1 shows a lighting system comprising a control device according to one exemplary embodiment of the invention.

FIG. 2 is a flowchart of a method according to one exemplary embodiment.

FIG. 3 is a circuit diagram of a control device according to one exemplary embodiment for elucidating an identification of a zero crossing of a supply voltage.

FIG. 4 is a flowchart of a method according to one exemplary embodiment.

FIG. 5 shows a time-dependent profile of a current flowing through the control device to the load and of a detected voltage for elucidating the functioning of the control device.

FIG. 6 shows a time-dependent profile of a supply voltage for which a control device according to one exemplary embodiment generates phase cutting for the purpose of transmitting a data packet.

FIG. 7 is a circuit diagram of a control device according to one exemplary embodiment.

FIG. 8 is a circuit diagram of a control device according to one exemplary embodiment.

### DETAILED DESCRIPTION OF THE PREFERRED EMBODIMENTS

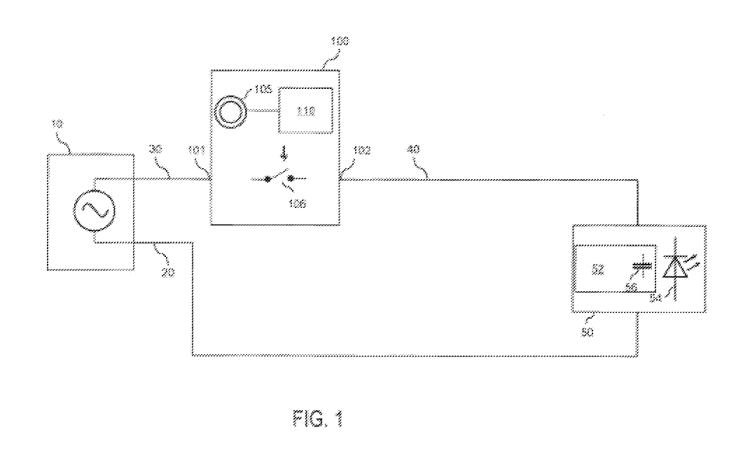

FIG. 1 illustrates a lighting system comprising a control device 100 according to one exemplary embodiment of the invention. The lighting system comprises the control device 100, a supply source 10, for example a power supply system voltage source, and one luminaire 50 or a plurality of luminaries 50. The luminaire 50 is controlled by the control device 100. For this purpose, the control device 100 transmits a data packet via a load line. For the purpose of transmitting a plurality of data bits of the data packet, the supply voltage is influenced by the control device 100 in a manner temporally coordinated with zero crossings of the supply voltage, for example for the purpose of generating phase gating or phase cutting of half-cycles of the supply voltage. In the explanations below it will be assumed that the control device 100 serves for controlling the brightness of the lighting device 50, i.e. is configured as a dimmer. The control device 100 can also be usable for alternative or additional control processes, for example for color control.

The luminaire 50 comprises an operating device 52 and an illuminant 54. The illuminant 54 can comprise one or a plurality of light emitting diodes (LEDs). The operating device 52 can correspondingly be configured as an LED converter. It goes without saying here that the illuminants 54 can be implemented in various ways, e.g. by one or a plurality of inorganic LEDs, organic LEDs, gas discharge lamps or other illuminants. Furthermore, a combination of the abovementioned types of illuminant can also be used. Suitable operation of the respective illuminant 54 is effected by means of the operating device 52. For this purpose, the operating device 52 can comprise a power supply unit, for example, which generates a suitable voltage and/or a suitable current from a supply voltage fed to the luminaire for the purpose of operating the illuminant 54. For non-conventional illuminants, for example for LEDs, the operating device 52 constitutes a non-ohmic load. By way of example, an interference-suppression capacitor 56 connected to the inputs of the operating device 52 can bring about a phase shift between current and supply voltage.

A power supply system voltage conductor 20 proceeding from the power supply system voltage source 10 is connected to the luminaire 50. A further power supply system voltage conductor 30 proceeding from the power supply system voltage source 10 is connected to the control device 100. The power supply system voltage conductor 20 can be a neutral conductor, while the power supply system voltage conductor 30 is a phase conductor. The control device 100 is connected to the luminaire 50 via a load line 40. The luminaire 50 is coupled to the power supply system voltage conductor 20 and the load line 40 and takes up its supply voltage via the load line 40 and the power supply system voltage conductor 20. The supply voltage of the operating device is thus fed to them via, on the one hand, the power supply system voltage conductor 20 and, on the other hand, via the power supply system voltage conductor 30, the load line 40 and the control device 100 coupled therebetween. The control device 100 is directly connected only to one of the power supply system voltage conductors 20, 30. A connection of the control device 100 to the neutral conductor is not necessary, which reduces the installation outlay.

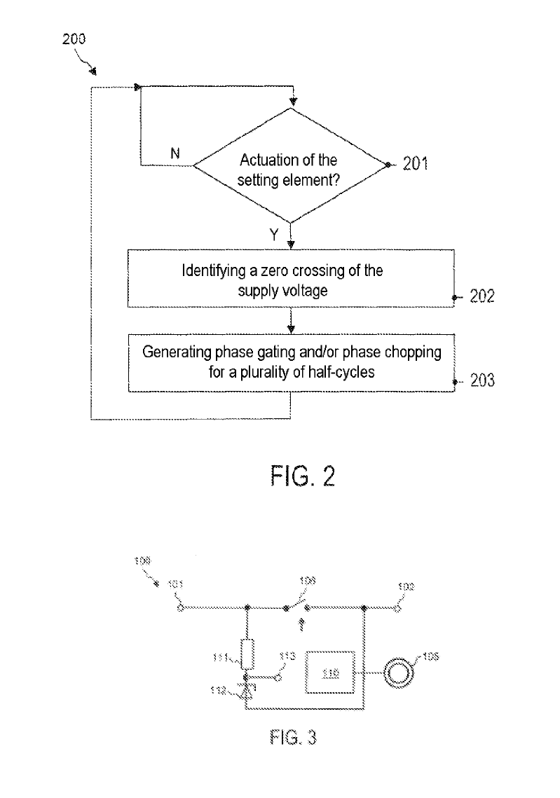

The control device 100 comprises a control circuit 110 and a setting element 105. The control circuit 110 has the task of influencing a supply voltage for the luminaire 50 in a targeted manner such that a plurality of data bits of a data packet are transmitted via the load line 40. By way of example, half-cycles with phase gating and/or phase cutting can be generated for this purpose. For this purpose, the control circuit 110 can control a switching means 106, for example a MOSFET or some other power semiconductor component, in particular a power semiconductor component having an insulated gate electrode. As described in even greater detail with reference to FIG. 2 to FIG. 8, the control circuit 110 can firstly perform a method for identifying a zero crossing of the supply voltage. In this case, a line path between an input terminal 101 and an output terminal 102 of the control device 100 is switched into a high-impedance state for a time interval, that is to say that the control device 100 is switched into an off state in which a current flow between supply source 10 and load 50 through the control device 100 is greatly reduced or completely prevented. During the time interval, a voltage occurring in the control device 100 is monitored in order to identify a zero crossing of the supply voltage. The control circuit 110 subsequently controls the switching means 106, for example, in a predefined temporal relation with zero crossings of the supply voltage in order to transmit a data packet having a plurality of data bits in a plurality of half-cycles of the supply voltage. The plurality of data bits can code a dimming value and/or a color value or some other manipulated variable of the luminaire.

The corresponding data packet with which the control device 100 controls the luminaire 50 can be influenced by actuation of the setting element 105. The setting element 105 can comprise a pushbutton switch, for example. Upon actuation of the setting element 105, a sequence of half-cycles with phase gating and/or phase cutting can be generated in order to transmit a data packet which causes the luminaire 50 to change the brightness. By way of example, by means of actuations of the setting element 105, the brightness can be increased by one step in each case until a maximum brightness is reached, and afterward, by means of actuations of the setting element 105, the brightness can in turn be reduced by one step in each case until a minimum brightness is reached. Furthermore, upon permanent actuation of the setting element 105, the brightness can automatically be varied in a periodic manner and the brightness set when the setting element 105 is released can be maintained. It goes without saying that there are furthermore diverse further possibilities for controlling the luminaries 50 by means of the setting element 105. The setting element 105 can for example also comprise a potentiometer coupled to a rotary head by means of which the desired brightness is settable. In this case, upon actuation of the setting element 105, the control device 100 can detect the position of the potentiometer and, by means of the control circuit 110, generate a data packet for setting the corresponding brightness and communicate it to the luminaire 50.

FIG. 2 is a flowchart of a method 200 which can be performed automatically by the control device 100. In the method, step 201 involves monitoring whether the setting element 105 of the control device 100 is actuated. If an actuation of the setting element 105 is identified, step 202 involves performing a procedure which ascertains an instant at which the supply voltage has a zero crossing. A phase angle of the supply voltage can be determined as a result. The determination of the zero crossing of the supply voltage that is performed in step 202 enables a reliable transmission of a data packet even if a non-ohmic load is connected to the load line. In step 203, using the zero crossing of the supply voltage identified in step 202, the supply voltage is influenced in a targeted manner in order to transmit a data packet. The supply voltage can be modulated in order to transmit the data packet. By way of example, phase gating and/or phase cutting can be generated in predefined time intervals after or before a zero crossing of the supply voltage. The data packet can comprise a value coded in a bit sequence, for example a dimming value and/or a color value. The data packet can be generated depending on a dimming value or color value set by means of the setting element 105.

While FIG. 2 schematically illustrates a method in which an actuation of the setting element in step 201 initiates the determination of the phase angle of the supply voltage and the transmission of a data packet, the performance of the method can also be initiated by other events. This may be the case for example upon automatic dimming or automatic color control in accordance with a timing sequence schedule.

The determination of the instant at which the supply voltage has a zero crossing is explained in greater detail with reference to FIGS. 3 to 5. Generally, the control device 100 is configured such that a line path between the input terminal 101 and the output terminal 102 of the control device 100 is switched into a high-impedance state in a targeted manner for a time interval. A current flow from the input terminal 101 to the luminaire 50 via the load line 40 can thus be interrupted or greatly reduced. A voltage dropped in the control device 100 is monitored during this time interval. A zero crossing of said voltage corresponds to a zero crossing of the supply voltage provided by the supply source.

FIG. 3 is a circuit diagram of the control device 100 according to one exemplary embodiment for elucidating the identification of the zero crossing. A switching means 106 is connected between the input terminal 101 and the output terminal 102 of the control device 100. The switching means 106 can be configured such that it is in an on state, that is to say a state having low resistance, if the supply source supplies a supply voltage and the control circuit 110 does not switch the switching means 106 into an off state in a targeted manner. The switching means 106 can comprise a MOSFET or some other power semiconductor component, in particular some other power semiconductor component having an insulated gate electrode.

For determining the zero crossing of the supply voltage, the control circuit 110 switches the switching means 106 into an off state. The line path between the input terminal 101 and the output terminal 102 is thus switched into a high-impedance state. If the operating device of the luminaire supplied with energy via the output terminal 102 has an interference-suppression capacitor, the latter can then be discharged while the switching means 106 is switched into the off state. The interference-suppression capacitor of the operating device can be discharged via the illuminant, in particular.

The control circuit 110 can be designed such that it identifies a zero crossing of a voltage in the control device 100, while the switching means 106 is switched into the off state. For this purpose, the voltage dropped across a Zener diode 112 or a resistor 112 in the control device 100 can be monitored for example at a measuring point 113. The Zener diode 112 or the resistor 112 can be connected with a resistor 111 in a series circuit between the input terminal 101 and the output terminal 102. While the interference-suppression capacitor of the operating device is discharged, the detected voltage approaches the supply voltage. A zero crossing of the voltage detected in the control device 100, if the switching means 106 is switched into the off state, corresponds to a zero crossing of the supply voltage.

After the zero crossing of the supply voltage has been identified, the control circuit 110 ends the control process with which the switching means 106 was switched into the off state. The switching means 106 returns to the on state. By way of example, a MOSFET can be switched into a low-impedance state for this purpose. The resistance of the line path between the input terminal 101 and the output terminal 102 is thus reduced in order to allow a current flow between supply source 10 and luminaire 50 via the control device 100. The control circuit 110 can switch the switching means 106 into the off state in each case in a time window for a sequence of half-cycles of the supply voltage in order to generate phase gating or phase cutting. The presence or absence of phase gating or phase cutting in the half-cycles of the sequence of half-cycles makes it possible to transmit a sequence of data bits.

The time duration in which the voltage detected in the control circuit falls to a zero value after the switching means 106 has been switched into the off state depends on the magnitude of the phase shift between current and supply voltage. The phase shift in turn depends on the operating device 50. The operating device 50 advantageously has a charging capacitor, which ensures that the illuminant is supplied with energy during the time interval in which the control circuit 110 switches the switching means 106 into the off state for the purpose of identifying the zero crossing of the supply voltage. In the case of a substantially ohmic load, the duration of the time interval in which the switching means 106 is switched into the off state is typically short. A relatively small charging capacitor can prevent the illuminant from ceasing to shine. In the case of a capacitive load, there is a longer duration until the interference-suppression capacitor of the operating device is discharged and zero crossing of the supply voltage is identified. In this case, a charging capacitor configured to operate the illuminant with maximum brightness during the discharge time of the interference-suppression capacitor prevents the illuminant from ceasing to shine.

A corresponding design of the charging capacitor of the operating device thus makes it possible to ensure that the illuminant does not cease shining while the control device 100 performs the procedure for determining the zero crossing of the supply voltage.

The control of the switching means 106 in such a way that said switching means is switched into a high-impedance state in order to determine the zero crossing of the supply voltage can be carried out in a manner coordinated with the current flowing via the load line 40. For this purpose, the control circuit 110 can monitor the current. The control circuit can switch the switching means 106 into the off state upon a zero crossing of the current and can subsequently determine the instant at which the voltage detected in the control device has a first zero crossing. The identification of the zero crossing of the supply voltage can thus take place in a time interval which is defined depending on a zero crossing of the current. The identification of the zero crossing of the supply voltage can take place in particular in a time interval which starts upon a zero crossing of the current which flows through the control device to the operating device of the illuminant.

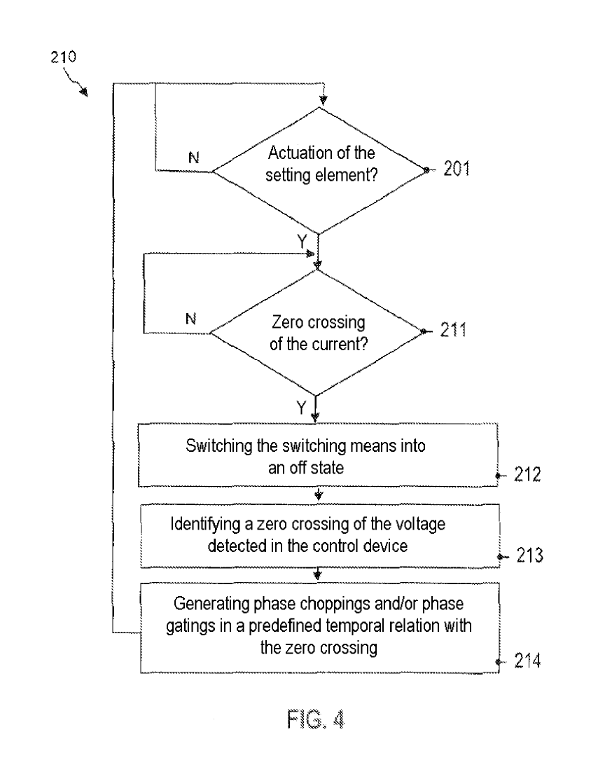

FIG. 4 is a flowchart of a method 210 for data transmission via a load line. The method 210 can be performed automatically by the control device 100. In step 201, an event that initiates the performance of the method for data transmission can be monitored. As explained with reference to FIG. 2, the actuation of a setting element can be monitored, for example. As soon as an event that initiates the transmission of a data packet via the load line is identified, step 211 involves monitoring when the current flowing via the load line 40 has a zero crossing.

In step 212, a zero crossing of the current initiates a control of the switching means 106 in such a way that the switching means is switched into an off state. By way of example, a MOSFET can be switched into a high-impedance state for this purpose. Step 213 involves monitoring when a voltage dropped in the control device 100 has a zero crossing. For this purpose, by way of example, a voltage dropped across a Zener diode 112 or a resistor 112 can be detected and the zero crossing of said voltage can be identified, as has been described with reference to FIG. 3. The switching means 106 remains switched into the off state until the zero crossing of the voltage detected in the control device 100 is identified. This instant corresponds to a zero crossing of the supply voltage.

After the zero crossing of the supply voltage has been determined, a plurality of data bits is transmitted in step 214. Phase gating and/or phase cutting of half-cycles of the supply voltage can be generated for this purpose. The time windows in which the switching means 106 is in each case switched into the off state in order to generate a phase gating and/or phase cutting are chosen depending on the zero crossing of the supply voltage identified in step 213 such that they are in a predefined temporal relation with zero crossings of the supply voltage. By way of example, for the purpose of generating a phase gating, the control circuit 110 can switch the switching means 106 into an off state in a time window which begins with a zero crossing of the supply voltage. For the purpose of generating a phase cutting, the control circuit 110 can switch the switching means 106 into an off state in a time window which ends with a zero crossing of the supply voltage. Phase gating or phase cutting can be generated selectively for a plurality of half-cycles of a sequence of half-cycles of the supply voltage in order thus to transmit a sequence of data bits. Two data bits can be converted per full cycle of the supply voltage if a data packet is transmitted. The data packet can comprise for example ten data bits or more than ten data bits. During the transmission of a data packet, for example in five full cycles of the supply voltage, the zero crossing of the supply voltage need not be determined anew. The procedure for determining the phase angle of the supply voltage can be repeated, for example, if a new data packet is transmitted or if the time that has elapsed since the last determination of the zero crossing of the supply voltage exceeds a threshold value.

FIG. 5 is a diagram for further elucidation of the functioning of the control device according to exemplary embodiments when determining the zero crossing of the supply voltage. After an event that initiates the procedure for determining the zero crossing of the supply voltage, a zero crossing 222 of a current 221 that flows via the load line 40 is identified. The identification of the zero crossing 222 can be carried out for example by means of a measuring resistor or by any other circuit arrangement configured to identify the current zero crossing while the switching means 106 is switched into the on state. Upon the zero crossing 222 of the current 221, the control circuit 110 controls the switching means 106 such that said switching means 106 is switched into the off state. The line path between input terminal 101 and output terminal 102 of the control device 100 thereby acquires high impedance. In a time interval 226 in which the switching means 106 remains switched into the off state, the first zero crossing of a voltage 223 is identified. The interference-suppression capacitor of the operating device of the illuminant is discharged during the time interval 226. The voltage 223 detected in the control device, which voltage has a phase shift with respect to the supply voltage if the switching means 106 is currently switched to the off state, approaches the supply voltage with the discharging of the interference-suppression capacitor of the operating device. Upon the zero crossing 224 of the voltage 223, the supply voltage also has a zero crossing. The instant 225 thus determined when the supply voltage has a zero crossing can be used to generate phase gating or phase cutting for a sequence of half-cycles of the supply voltage. The switching means can be switched into the on state again at the instant 225.

In order to prevent the illuminant from ceasing to shine during the time interval 226, the operating device can have a charging capacitor. The charging capacitor can be designed such that it can maintain operation of the illuminant at 100% brightness during a discharge time of the interference-suppression capacitor of the operating device.

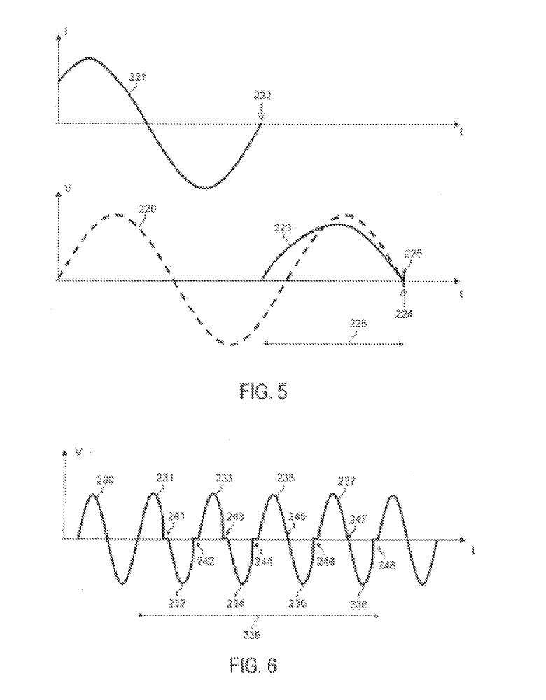

FIG. 6 illustrates how the control device 100 generates phase cutting for the purpose of data transmission. For this purpose, the control circuit 110 switches for example the switching means 106 into an off state in a manner temporally coordinated with the zero crossings of the supply voltage. A supply voltage 230 provided to the operating device 52 of the luminaire has a plurality of half-cycles 231-238. A plurality of the half-cycles have phase cutting. The phase cutting are generated by the control device 100 such that a logic “0” or a logic “1” can be coded for example by the presence or absence of a phase cutting in the case of a half-cycle. A first half-cycle 231 of the sequence of half-cycles can have a phase cutting 241. A start bit of a data packet can be coded thereby. At least one half-cycle 238 of the sequence of half-cycles can have a phase cutting 248 in order to indicate the end of the data packet. For the intervening half-cycles 232-237, phase cutting can be generated selectively in order to transmit a dimming value, a color value or some other bit sequence. By way of example, one bit value, e.g. a logic “1”, can respectively be coded by means of the phase cutting 242, 243, 244 and 246 of the half-cycles 232, 233, 234 and 236. Another bit value, e.g. a logic “0”, can respectively be coded by the absence of phase cutting 245 and 247 in the case of the other half-cycles 235 and 237. Other configurations are possible. By way of example, instead of a target value for a brightness or a color, which target value is intended to be approached by the operating device in a changeover process, it is also possible merely to communicate information in the data packet about whether a brightness value, a color value or some other manipulated variable is intended to be incremented or decremented.

The operating device 50 has an evaluation circuit, which monitors the received supply voltage for the presence of phase gating and/or phase cutting. The evaluation circuit can identify the start of a data packet on the basis of at least one phase gating or phase cutting. The evaluation circuit can ascertain the control command communicated with the data packet, for example a target value of a manipulated variable. The operating device implements the control command, for example by approaching the target value of the manipulated variable with a changeover time. If a command for incrementing or decrementing the manipulated variable is transmitted with the data packet, said command being coded in a sequence of phase gating and/or phase cutting, the operating device can likewise carry out a corresponding changeover process.

As illustrated schematically in FIG. 6, during the transmission of the data packet phase cutting or phase gating can be generated both for half-cycles having a positive sign and for half-cycles having a negative sign. This allows the transmission of two data bits per full cycle of the supply voltage, while the data packet is transmitted. In further configurations, it is also possible to transmit fewer than two data bits per full cycle.

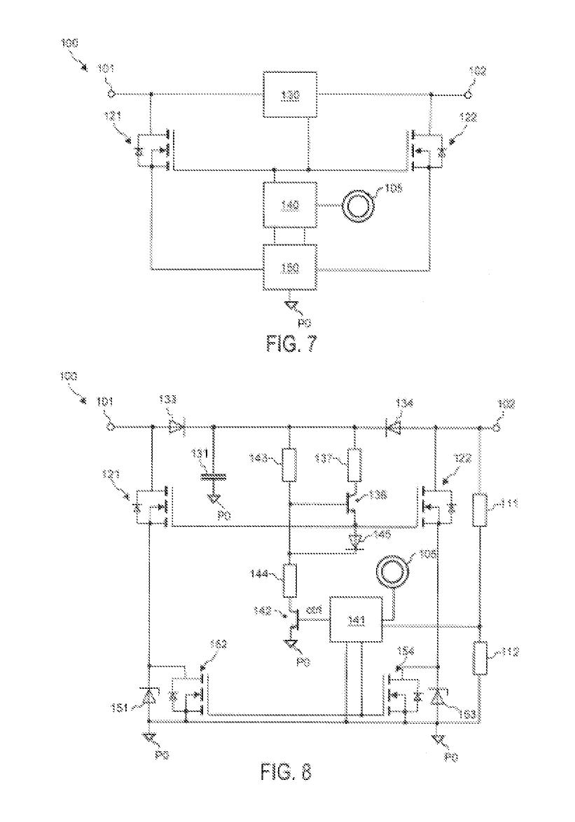

While with reference to FIG. 1 and FIG. 3 an explanation has been given of configurations of the control device 100 comprising one switching means 106, which is switched into an off state by the control circuit 110 in a targeted manner, a plurality of switching means can also be provided. In particular, the control circuit 110 can comprise a series circuit comprising a first switching means and a second switching means, said series circuit being connected between the input terminal 101 and the output terminal 102 of the control device. The first switching means and the second switching means can in each case be a power semiconductor component having an insulated gate electrode. The first switching means and the second switching means can in each case be a power MOSFET or comprise a power MOSFET. Such configurations make it possible, in a particularly simple manner, by means of two power switches in a series circuit, to generate phase gating or phase cutting both for half-cycles of the supply voltage having a positive sign and for half-cycles of the supply voltage having a negative sign. Configurations of such circuits are described in greater detail with reference to FIG. 7 to FIG. 8. In this case, similar reference signs designate similar elements or assemblies.

FIG. 7 is a circuit diagram of a control device 100 according to one exemplary embodiment. The control device 100 comprises a first switching means 121 and a second switching means 122. The first switching means 121 and the second switching means 122 are connected in a series circuit between the input terminal 101 and the output terminal 102 of the control device 100. The control device 100 comprises a control circuit 140, which is configured to switch in each case at least one of the two switching means 121, 122 into an off state.

The first switching means 121 and the second switching means 122 can be configured in each case as a power MOSFET. Other power switches, in particular, power semiconductor components having an insulated gate electrode, can be used. In this case, the first switching means 121 and the second switching means 122 can be switched such that the forward direction of the fundamentally integrated diodes of the power MOSFETs for the two switching means 121, 122 are opposite to one another.

The first switching means 121 and the second switching means 122 can be in an on state if the supply source supplies a supply voltage and the control circuit 140 does not discharge the gates of the power MOSFETs. A charging circuit 130 can be used to charge the gates of the first switching means 121 and of the second switching means 122. The charging circuit 130 can be coupled to the input terminal 101 and the output terminal 102. The charging circuit 130 is configured to charge the gates of the first switching means 121 and of the second switching means 122 in order to switch both switching means 121, 122 into an on state. The charging circuit 130 can comprise a capacitor or some other energy storage means in order to charge the gates of the first switching means 121 and of the second switching means 122 again relatively rapidly if the control circuit 140 no longer switches the series circuit into an off state. Phase gating or phase cutting with relatively steep voltage edges can be generated in this way.

The control circuit 140 can be coupled to the gates of the first switching means 121 and of the second switching means 122 in order to discharge the gates. The series circuit formed by the first switching means 121 and the second switching means 122 can thereby be switched into a high-impedance state. As described with reference to FIG. 1 to FIG. 6, the control circuit 140 can switch the series circuit formed by the switching means 121 and the second switching means 122 into an off state in order to carry out a procedure for determining a zero crossing of the supply voltage. For this purpose, the control circuit 140 can bring about a discharge of the gates of the first switching means 121 and of the second switching means 122 if a zero crossing of the current which flows via the switching means 121, 122 and via the load line to the operating device of the luminaire is identified. The control circuit 140 can cause the gates of the first switching means 121 and of the second switching means 122 to be discharged again for the purpose of generating phase gating and/or phase cutting, in order to generate a phase gating and/or phase cutting in time windows that are in a predetermined temporal relation with zero crossings of the supply voltage. In order to perform the various functions mentioned, the control circuit 140 can comprise at least one logic circuit, which can be configured as an integrated circuit. The control circuit 140 can comprise at least one microprocessor or controller in order to perform the functions mentioned.

An internal supply voltage for the control circuit 140 can be provided by means of a supply circuit 150. The control device 100 can also be configured such that a bridging contact of the setting element 105 bridges the input terminal 101 and the output terminal 102 as long as the setting element 105 is not actuated. What can be achieved in this way is that the control circuit is supplied with voltage only upon actuation of the setting element 105, such that a power consumption of the control device 100 is reduced.

The functioning of the control device 100 when determining the zero crossing of the supply voltage and when generating phase gating and/or phase cutting for transmitting a sequence of data bits corresponds to the functioning described with reference to FIG. 1 to FIG. 6.

FIG. 8 is a circuit diagram of a control device 100 according to one exemplary embodiment. The control device 100 comprises a first switching means 121, a second switching means 122 and a control circuit 140, which can be configured as described with reference to FIG. 7.

A charging circuit for charging the gates of the first switching means 121 and of the second switching means 122 comprises a diode 133, which is connected to the input terminal 101 and which is connected via a resistor 137 and a switch, for example a transistor 136, to the gates of the first switching means 121 and of the second switching means 122. The charging circuit comprises a further diode 134, which is connected to the output terminal 102 and which is connected via the resistor 137 and the switch, for example the transistor 136, to the gates of the first switching means 121 and of the second switching means 122. The charging circuit can comprise a capacitor 131, which is charged via the diode 133 and the further diode 134. A further terminal of the capacitor 131 is coupled to a ground potential P0. The capacitor 131 stores charge for rapid charging of the gates of the first switching means 121 and of the second switching means 122, for example at the end of a phase gating or phase cutting.

As explained with reference to FIG. 7, the control circuit is configured to switch the series circuit formed by the first switching means 121 and the second switching means 122 into an off state. The resistance of the line path through the series circuit formed by the first switching means 121 and the second switching means 122 is thereby increased. For the purpose of discharging the gates, the control circuit can produce a connection between the gates and ground, for example by driving a transistor 142. In addition, for the purpose of discharging the gates, the control circuit can switch a switch, which can be realized for example as a further transistor 136, between the capacitor 131 and the gates of the first switching means 121 and of the second switching means 122 into an off state in order to temporarily prevent renewed charging of the gates.

In the embodiment illustrated, the control circuit, which can increase the resistance of the series circuit formed by the first switching means 121 and the second switching means 122, comprises an integrated circuit 141, a transistor 142 and a voltage divider comprising resistors 143 and 144. The integrated circuit 141 can be configured as a processor, microcontroller, controller or other integrated circuit. The control device 100 is configured such that the gates of the switching means 121, 122 are charged if a signal of the supply source is present at the input terminal 101. The integrated circuit 141 can generate and output a control signal ctrl in order to turn on the transistor 142. The resistor 144 acts a pull-down resistor. The resistor 144 is coupled to the transistor 142 and to a gate of the transistor 136. The potential at the gates of the first switching means 121 and of the second switching means 122 is pulled in the direction of a ground potential P0. The gates of the first switching means 121 and of the second switching means 122 can be discharged via a diode 145.

The control circuit can prevent renewed charging of the gates of the first switching means 121 and of the second switching means 122, while the control signal ctrl is generated. For this purpose, a further transistor 136, which is connected between the capacitor 131 and the gates of the first switching means 121 and of the second switching means 122, can undergo transition to an off state. In the case of the embodiment illustrated, a potential at the gate of the further transistor 136 is influenced by means of a voltage divider comprising the resistor 144 and a further resistor 143 such that the further transistor 136 is turned off while the control signal ctrl turns on the transistor 142. If the control signal ctrl is no longer generated, that is to say if, for example, the potential at the corresponding output of the integrated circuit 141 returns to a lower value, the transistor 142 is turned off. Charge for renewed charging of the gates of the first switching means 121 and of the second switching means 122 can be provided by the capacitor 131. The gates of the first switching means 121 and of the second switching means 122 can be charged via the further transistor 136 and a resistor 137 if the supply source provides a signal at the input terminal 101 and the integrated circuit 141 does not control the transistor 142 such that the potential at the gates of the first switching means 121 and of the second switching means 122 is influenced in order to increase the resistance of the series circuit.

The control circuit can be supplied with energy by a supply circuit comprising at least two Zener diodes. In the case of the configuration illustrated in FIG. 8, a Zener diode 151 and a power MOSFET 153 and also a further Zener diode 155 and a further power MOSFET 154 are provided in order to supply the control circuit 140 with energy. Other configurations are possible in order to generate an internal supply voltage for the control circuit 140.

A voltage measurement for determining the zero crossing of the supply voltage, which is carried out while the series circuit formed by the first switching means 121 and the second switching means 122 is in a high-impedance state, can be carried out by the integrated circuit 141. By way of example, a voltage dropped across the second switching means 122 can be monitored while the signal ctrl turns on the transistor 142 in order to switch the series circuit formed by the first switching means 121 and the second switching means 122 into an off state.

The functioning of the control device 100 when determining the zero crossing of the supply voltage and when influencing the supply voltage for the purpose of transmitting a data packet corresponds to the functioning described with reference to FIG. 1 to FIG. 7.

One possible exemplary embodiment of a control device 100 is explained below. The control device 100 comprises a first switching means 121, a second switching means 122 and a control circuit, which can be configured as described with reference to FIG. 7. The control circuit comprises an integrated circuit 141. The integrated circuit 141 can be configured as a controller or processor. Only the circuit components of the control device 100 which are relevant to the understanding of the invention are described in detail below.

The control device comprises a charging circuit for charging the gates of the first switching means 121 and of the second switching means 122. The charging circuit comprises a capacitor 131 and diodes 133, 134. The capacitor 131 is charged via the diodes 133, 134 if the supply source supplies a supply voltage. The charging circuit furthermore comprises a transistor 136 connected to the gates of the first switching means 121 and of the second switching means 122. The charging circuit keeps the series circuit formed by the first switching means 121 and the second switching means 122 in an on state, i.e. in a low-impedance state, if the supply source supplies a supply voltage and the control circuit does not discharge the gates of the first switching means 121 and of the second switching means 122.

In order to switch the series circuit formed by the first switching means 121 and the second switching means 122 into an off state, the integrated circuit 141 controls a transistor 142, as described with reference to FIG. 8. An output signal of the integrated circuit 141 controls a potential at the gate of the transistor 142. If the transistor 142 is switched into an on state, the gate voltage of the transistor 136 is pulled in the direction of the ground potential by means of a voltage divider comprising resistors 143 and 144. The transistor 136 is thus switched into an off state. Renewed charging of the gates of the first switching means 121 and of the second switching means 122 by the capacitor 131 is suppressed in this way. The gates of the first switching means 121 and of the second switching means 122 are discharged, for example via a diode 145, the resistor 144 and via the transistor 142.

In order to end the selective switching of the series circuit formed by the first switching means 121 and the second switching means 122 into the off state, the integrated circuit 141 no longer outputs a signal to the gate electrode of the transistor 142. The transistor 142 is turned off. The gates of the first switching means 121 and of the second switching means 122 are charged by the capacitor 131 via the transistor 136. The series circuit formed by the first switching means 121 and the second switching means 122 correspondingly reverts to an on state, in which it has a lower resistance. The use of the capacitor 131 makes it possible to achieve a rapid return to the on state.

The functioning of the control device 100 when determining the zero crossing of the supply voltage and when influencing the supply voltage for the purpose of transmitting a sequence of data bits corresponds to the functioning described with reference to FIG. 1 to FIG. 8. The detection of the voltage in the control device while the series circuit formed by the first switching means 121 and the second switching means 122 is switched into an off state can be carried out at suitable measuring points. By way of example, the integrated circuit 141 can detect a voltage dropped across the second switching means 122 via a resistor 111 and Zener diode 112 or resistor 112 in order to determine a zero crossing of the supply voltage.

While control devices and methods according to exemplary embodiments have been described in detail with reference to the figures, modifications can be realized in further configurations. By way of example, other controllable power switches can be used instead of power MOSFETs. Instead of n-channel MOSFETs that are switched into a high-impedance state by discharge of the gates, use can also be made of p-channel MOSFETs. The control circuit would accordingly bring about charging of the gates of the switching means in order to increase the resistance of the line path between input terminal and output terminal. While the control device can comprise two switching means in a series circuit in order to generate a phase gating both in the case of half-cycles of the supply voltage having a positive sign and in the case of half-cycles having a negative sign, in further exemplary embodiments the data transmission can be effected such that a phase gating or phase cutting is generated only for half-cycles having one specific sign. In this case, it is also possible to transmit only one data bit per full cycle of the supply voltage. Bipolar transistors that were described with reference to some exemplary embodiments can also similarly be replaced by other controllable switching means.

While control devices and methods according to exemplary embodiments can be used for transmitting dimming commands and/or for color control, target values for other manipulated variables can also be transmitted. In all of the exemplary embodiments, the data transmission can take place once the illuminant is already emitting light. The data transmission can take place via the load line without the illuminant ceasing to shine.

While the coding of data bits by the generation of a phase gating or phase cutting has been described, the supply voltage can also be influenced in some other way in order to transmit a sequence of data bits with a sequence of half-cycles of the supply voltage. By way of example, the supply voltage provided to the operating device by the control device can also be decreased substantially to zero during a time window which lies neither at the beginning nor at the end of a half-cycle of the supply voltage.

In all of the embodiments, a bridging contact of the setting element can bridge the input terminal and the output terminal as long as the setting element is not actuated. What can be achieved in this way is that a voltage supply of the control circuit is effected only upon the actuation of the setting element, such that a power consumption of the control device can be reduced.

Devices and methods according to exemplary embodiments can be used, in particular, for controlling luminaries which comprise LEDs, without being restricted thereto.

1. A method for data transmission from a control device (100) to a load (50) via a load line (40), for data transmission to an operating device (52) for an illuminant (54), wherein the method comprises:
controlling a switching means (106; 121, 122) in order to increase a resistance of a line path between an input terminal (101) and an output terminal (102) of the control circuit (100),
detecting a voltage (223) in the control device (100) for identifying a phase angle of a supply voltage (220, 230), and
influencing the supply voltage (220, 230) depending on the identified phase angle and depending on data to be transmitted for transmitting a data packet.

2. The method as claimed in claim 1, further comprising:
monitoring a current (221) output via the output terminal (102) to the load line (40),
wherein the switching means (106; 121, 122) is switched into an off state upon a zero crossing (222) of the current (221).

3. The method as claimed in claim 1,
wherein detecting the phase angle comprises detecting a zero crossing (224) of the detected voltage (223),
wherein the supply voltage (220) is influenced in time windows which depend on a time (225) at which the zero crossing (224) of the detected voltage (223) occurs.

4. The method as claimed in claim 1, wherein a phase gating and/or phase cutting (241-244, 246, 248) of at least one half-cycle (231-234, 236, 238) of the supply voltage (220, 230) is generated.

5. The method as claimed in claim 4, wherein a phase gating and/or phase cutting (241, 242) are/is generated in each case for at least two half-cycles (231, 232) of the supply voltage (220, 230) which have different signs.

6. The method as claimed in claim 4,
wherein a phase gating and/or phase cutting (241-244, 246, 248) is generated selectively in each case for a plurality of half-cycles (231-234, 236, 238) of a sequence of half-cycles (231-238) of the supply voltage (220, 230) in order to code a dimming value and/or a color value.

7. The method as claimed in claim 4, wherein, for the purpose of generating the phase gating and/or phase cutting (241-244, 246, 248), the switching means (106) is switched into an off state in a manner temporally coordinated with the identified phase angle.

8. The method as claimed in claim 1, wherein at least two data bits are transmitted per full cycle of the supply voltage (220, 230).

9. The method as claimed in claim 1, wherein the input terminal (101) of the control device (100) is coupled to a phase conductor (30) of a supply source (10) and the output terminal (102) of the control device (100) is coupled to the load line (40), wherein the control device (100) has no terminal for a neutral conductor (20) of the supply source (10).

10. The method as claimed in claim 1, further comprising:
monitoring an actuation of a setting element (105) of the control device (100), wherein the switching means (106; 121, 122) is controlled if an actuation of the setting element (105) is identified.

11. A control device, comprising:
an input terminal (101) configured to be coupled to a phase conductor (30) of a supply source (10),
an output terminal (102) configured to be coupled to a load line (40) for supplying a load (50), and
a control circuit (110; 140; 141-145) designed
to interrupt a current supply for the load (50),
to detect a voltage (223) in the control device (100) while the current supply for the load (50) is interrupted, in order to identify a phase angle of a supply voltage (220, 230), and
to influence the supply voltage (220, 230) depending on the identified phase angle and depending on data to be transmitted for transmitting a data packet.

12. A control device, comprising:
an input terminal (101) configured to be coupled to a phase conductor (30) of a supply source (10),
an output terminal (102) configured to be coupled to a load line (40) for supplying a load (50), and
a control circuit (110; 140; 141-145) designed
to interrupt a current supply for the load (50),
to detect a voltage (223) in the control device (100) while the current supply for the load (50) is interrupted, in order to identify a phase angle of a supply voltage (220, 230), and
to influence the supply voltage (220, 230) depending on the identified phase angle and depending on data to be transmitted for transmitting a data packet,
wherein the control circuit (110; 140; 141-145) is configured to carry out the method as claimed in claim 1.

13. The control device as claimed in claim 11, wherein the control device is configured as a dimmer.

14. A lighting system, comprising:
at least one operating device (52) for an illuminant (54), and
a control device (100) as claimed in claim 11, which is coupled to the at least one operating device (52) via a load line (40).

15. The lighting system as claimed in claim 14, wherein the at least one operating device (52) comprises at least one LED converter.
